(19) United States
(12) Patent Application Publication
(10) Pub. No.: US 2008/0136074 A1
(43) Pub. Date: Jun. 12, 2008

(54) Active vibration isolation support system

(75) Inventor: Hirotomi Nemoto, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/981,546

(22) Filed: Oct. 31, 2007

(30) Foreign Application Priority Data
Nov. 21, 2006 (JP) 2006-313756

(51) Int. Cl. F16F 15/00

(52) U.S. Cl. 267/140.14

(57) ABSTRACT

In an active vibration isolation support system, an actuator case is constituted by a resin member and holds an outer peripheral portion of an actuator in an upper housing and a lower housing which accommodate therein an elastic body, first and second liquid chambers, a movable member, and the actuator. The plastic actuator case is easily broken by an impact applied thereto upon collision, thereby easily breaking the upper housing apart from the lower housing. Therefore, an engine can move with respect to a vehicle body frame, thereby securing a clash stroke. Also, as compared with the case where the actuator case is constituted by an iron-based member, weight of the active vibration isolation support system is reduced.

### CROSS-REFERENCE TO RELATED APPLICATIONS

The present invention claims priority under 35 USC § 119 based on Japanese patent application No. 2006-313756, filed on Nov. 21, 2006. The subject matter of this priority document is incorporated by reference herein.

### BACKGROUND OF THE INVENTION

1. Field of the Invention

The present invention relates to an active vibration isolation support system comprising: an elastic body for elastically supporting a vibrating body in a support system; a liquid chamber defined by the elastic body and sealingly containing liquid therein; a movable member 28 for changing volume of the liquid chamber; an actuator 41 for driving the movable member; and a housing which accommodates therein the elastic body, the liquid chamber, the movable member and the actuator, and which is connected to the support system.

2. Description of the Related Art

Such an active vibration isolation support system is known by Japanese Patent Application Laid-open No. 2006-57750.

In this conventional active vibration isolation support system, a housing is made of iron-based material and an actuator case accommodated therein is also made of iron-based material, leading to a problem that the housing reinforced by the actuator case is not easily broken when a collision load is inputted to the active vibration isolation support system upon collision of a vehicle. Therefore, an engine, bound to a vehicle body frame through the active vibration isolation support system, is difficult to be moved rearward by an impact of the collision, so that a sufficient clash stroke cannot be secured, leading to a possibility that the impact absorbing performance upon collision is lowered.

### SUMMARY OF THE INVENTION

The present invention has been made in view of the above circumstances and has an object to provide an active vibration isolation support system wherein its housing is easily broken when a collision load is inputted to the active vibration isolation support system.

To achieve the above object, according to a first aspect of the present invention, there is provided an active vibration isolation support system comprising: an elastic body for elastically supporting a vibrating body in a support system; a liquid chamber defined by the elastic body and sealingly containing liquid therein; a movable member for changing volume of the liquid chamber; an actuator for driving the movable member; and a housing which accommodates therein the elastic body, the liquid chamber, the movable member and the actuator, and which is connected to the support system; and an actuator case comprising a resin member and holding an outer peripheral portion of the actuator in the housing.

Upper and lower housings 11, 12 of an illustrative non-limiting embodiment of the present invention correspond to the housing of the present invention, a first elastic body 19 of the embodiment corresponds to the elastic body of the present invention, first and second liquid chambers of the embodiment correspond to the liquid chamber of the present invention, an engine of the embodiment corresponds to the vibrating body of the present invention, and the vehicle body frame of the embodiment corresponds to the support system of the present invention.

With the first aspect, the actuator case holding the outer peripheral portion of the actuator to the housing which accommodates the elastic body, the liquid chamber, the movable member, and the actuator of the active vibration isolation support system is constituted by a resin member, so that the actuator case substantially made of resin can be easily broken by the impact upon collision to break the housing. Therefore, the vibrating body can be moved with respect to the support system, thereby securing a clash stroke. Also, the weight of the active vibration isolation support system can be reduced, as compared with the case where the actuator case is constituted by an iron-based member.

According to a second aspect of the present invention, in addition to the first aspect, the actuator case is molded while inserting a stator of the actuator therein.

With the second feature, the stator of the actuator is inserted into the actuator case when the actuator case is molded by resin, thereby reducing the number of assembling processes and also reducing the size of the entire actuator, as compared with the case where the stator is assembled to the actuator case.

According to a third aspect of the present invention, in addition to the first or second aspect, the actuator case is molded while inserting thereinto a cylindrical shell comprising a magnetic body surrounding an outer periphery of the actuator.

With the third feature, the cylindrical shell made of the magnetic body surrounding the outer periphery of the actuator is inserted into the actuator case when the actuator case is molded by resin. Although the actuator case is substantially made of resin with the non-magnetic body, the magnetic path of the actuator is formed by the shell, and moreover the weight is reduced as compared with the case where the entire actuator case is constituted by an iron-iron based member.

The above-mentioned object, other objects, characteristics, and advantages of the present invention will become apparent from preferred embodiment, which will be described in detail below by reference to the attached drawings.

### BRIEF DESCRIPTION OF THE DRAWINGS

FIG. 1 is a longitudinal sectional view of an active vibration isolation support system according to an illustrative embodiment of the present invention.

FIG. 2 is an enlarged view of Part 2 in FIG. 1.

FIG. 3 is a flowchart for explaining the operation of the active vibration isolation support system.

### DESCRIPTION OF THE PREFERRED EMBODIMENT

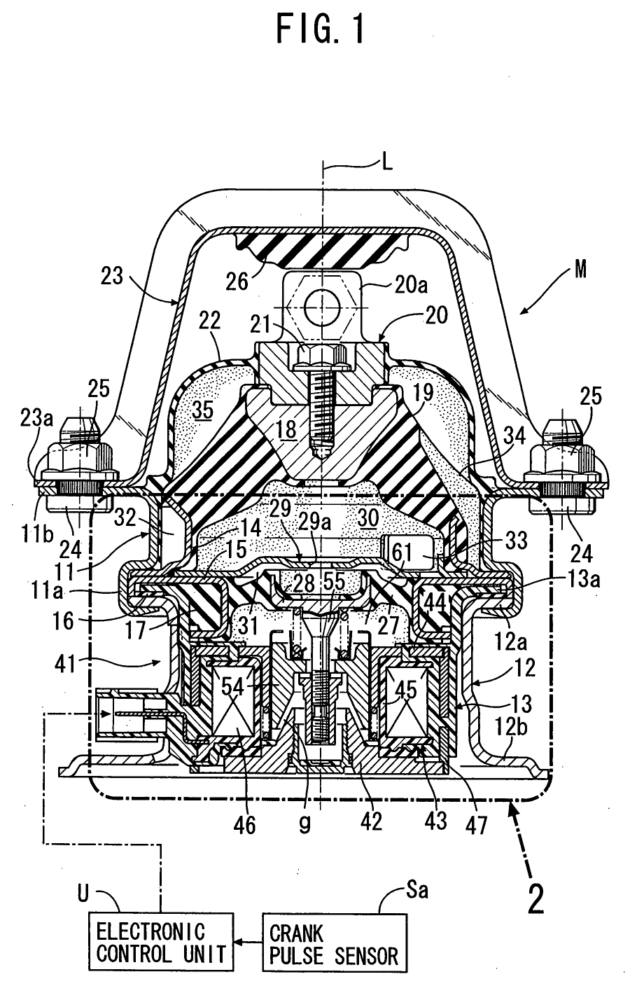

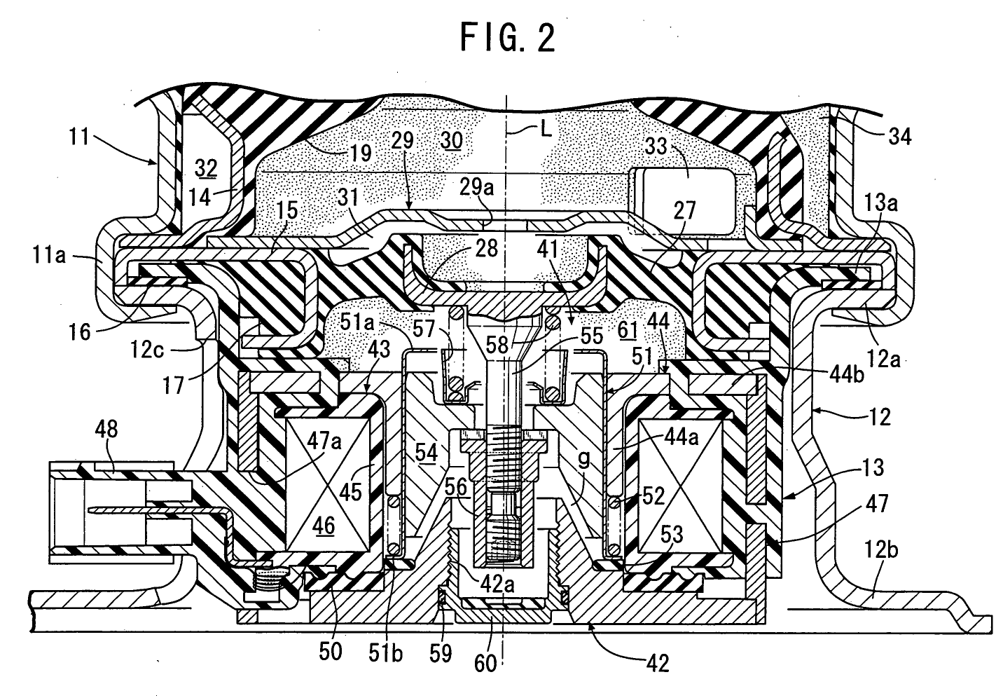

Referring to FIG. 1 and FIG. 2, an active vibration isolation support system M (active control mount) for elastically supporting an automobile engine in a vehicle body frame has a structure that is substantially symmetrical with respect to an axis L. In the active vibration isolation support system M, between a flange portion 11a at the lower end of a substantially cylindrical upper housing 11 and a flange portion 12a at the upper end of a substantially cylindrical lower housing 12, a flange portion 13a on the outer periphery of an upwardly opening substantially cup-shaped actuator case 13, an outer peripheral portion of an annular first elastic body support ring 14, and an outer peripheral portion of an annular second elastic body support ring 15 are superimposed and joined by crimping. In this process, an annular first floating rubber member 16 is disposed between the flange portion 12a of the lower housing 12 and the flange portion 13a of the actuator case 13, and an annular second floating rubber member 17 is disposed between an upper part of the actuator case 13 and an inner face of the second elastic body support ring 15, whereby the actuator case 13 is floatingly supported in the upper housing 11 and the lower housing 12 so as to be relatively movable with respect to them.

The upper housing 11 and the lower housing 12 are formed of iron-based material, and the actuator case 13 is formed of plastic resin.

Joined by vulcanization bonding to the first elastic body support ring 14 and a first elastic body support boss 18 disposed on the axis L, are the lower end and the upper end of a first elastic body 19 made of a thick rubber. A diaphragm support boss 20 is fixed to an upper face of the first elastic body support boss 18 by a bolt 21. An outer peripheral portion of a diaphragm 22, whose inner peripheral portion is joined by vulcanization bonding to the diaphragm support boss 20, is joined by vulcanization bonding to the upper housing 11. An engine mounting portion 20a integrally formed on an upper face of the diaphragm support boss 20 is fixed to the engine (unillustrated). A vehicle body mounting portion 12b at the lower end of the lower housing 12 is fixed to the vehicle body frame (unillustrated). The engine constitutes the vibrating body of the present invention, and the vehicle body frame constitutes the support system of the present invention.

A flange portion 23a at the lower end of a stopper member 23 is joined by bolts 24 and nuts 25 to a flange portion 11b at the upper end of the upper housing 11. The engine mounting portion 20a projectingly provided on the upper face of the diaphragm support boss 20 faces a stopper rubber member 26 attached to an upper inner face of the stopper member 23 so that the engine mounting portion 20a can abut against the stopper rubber member 26. When a large load is input to the active vibration isolation support system M, the engine mounting portion 20a abuts against the stopper rubber member 26, thereby suppressing excessive displacement of the engine.

An outer peripheral portion of a second elastic body 27, made of a membranous rubber, is joined by vulcanization bonding to the second elastic body support ring 15. A movable member 28 is embedded in and joined by vulcanization bonding to a central portion of the second elastic body 27. A disc-shaped partition member 29 is fixed between an upper face of the second elastic body support ring 15 and the outer peripheral portion of the first elastic body 19. A first liquid chamber 30 defined by the partition member 29 and the first elastic body 19, and a second liquid chamber 31 defined by the partition member 29 and the second elastic body 27, communicate with each other via a through hole 29a formed in the middle of the partition member 29.

An annular through passage 32 is formed between the first elastic body support ring 14 and the upper housing 11. One end of the through passage 32 communicates with the first liquid chamber 30 via a through hole 33, and the other end of the through passage 32 communicates via a through hole 34 with a third liquid chamber 35 defined by the first elastic body 19 and the diaphragm 22.

The structure of an actuator 41 for driving the movable member 28 is now described. When the actuator case 13 made of resin is molded, the stator 44 and the shell 47 are integrally inserted thereinto. The stator 44 comprises a cylinder portion 44a and a flange portion 44b. The outer peripheral portion of the flange portion 44b is inserted into the actuator case 13. The most part of the cylindrical shell 47 is inserted into the actuator case 13 except its lower end portion. The outer peripheral portion of the stationary core 42 is connected to the lower end of the shell 47. A coil assembly 43 is accommodated in a space surrounded by the stator 44, the shell 47 and the stationary core 42.

The coil assembly 43 comprises a bobbin 45 made of resin, and a coil 46 wound around the bobbin 45. The outer peripheral portion of the bobbin 45 is inserted into the actuator case 13 made of resin so that the coil assembly 43 becomes integral with the actuator case 13. A connector 48 is integrally formed in the actuator case 13. The connector 48 passes through openings 47a and 12c respectively formed in the shell 47 and the lower housing 12, and extends outside.

A seal member 50 is arranged between the lower face of the bobbin 45 and the upper face of the stationary core 42. The seal member 50 prevents water or dust from entering an inner space 61 of the actuator 41 through the opening 47a formed in the shell 47.

A thin cylindrical bearing member 51 is fitted, in a vertically slidable manner, into an inner peripheral face of a cylindrical portion 44a of the stator 44. An upper flange 51a and a lower flange 51b are formed at the upper end and the lower end respectively of the bearing member 51, the upper flange 51a being bent radially inward, the lower flange 51b being bent radially outward. A set spring 52 is disposed in a compressed state between the lower flange 51b and the lower end of the cylindrical portion 44a of the stator 44. The bearing member 51 is supported by the stator 44 by the lower flange 51b being pressed against the upper face of the stationary core 42 via an elastic body 53 by means of the elastic force of the set spring 52.

A substantially cylindrical movable core 54 is fitted, in a vertically slidable manner, into an inner peripheral face of the bearing member 51. A rod 55 extending downward from the center of the movable member 28 runs loosely through the center of the movable core 54, and a nut 56 is tightened around the lower end of the rod 55. A set spring 58 is disposed in a compressed state between a spring seat 57 provided on an upper face of the movable core 54 and a lower face of the movable member 28. The movable core 54 is fixed by being pressed against the nut 56 by means of the elastic force of the set spring 58. In this state, the lower face of the movable core 54 and the upper face of the stationary core 42 face each other across a conical air gap g. The rod 55 and the nut 56 are loosely fitted into an opening 42a formed in the center of the stationary core 42, and this opening 42a is blocked by a plug 60 via a seal 59.

An electronic control unit U, to which is connected a crank pulse sensor Sa for detecting a crank pulse that is outputted accompanying rotation of a crankshaft of the engine, controls the supply of current to the actuator 41 of the active vibration isolation support system M. The crank pulse of the engine is outputted 24 times per revolution of the crankshaft, that is, once every 15° of the crank angle.

The operation of the embodiment of the present invention, having the above-mentioned arrangement of parts, is now described.

When low frequency engine shake vibration occurs while the automobile is traveling, the first elastic body 19 is deformed by a load input from the engine via the diaphragm support boss 20 and the first elastic body support boss 18, thus changing the capacity of the first liquid chamber 30, so that a liquid moves to and fro between the first liquid chamber 30 and the third liquid chamber 35 via the through passage 32. When the capacity of the first liquid chamber 30 increases/decreases, the capacity of the third liquid chamber 35 decreases/increases correspondingly, and this change in the capacity of the third liquid chamber 35 is absorbed by elastic deformation of the diaphragm 22. The shape and the dimensions of the through passage 32 and the spring constant of the first elastic body 19 are set so that a low spring constant and high attenuation force are exhibited in the frequency region of the engine shake vibration. Therefore, it is possible to effectively suppress the vibration transmitted from the engine to the vehicle body frame.

In the frequency region of the engine shake vibration, the actuator 41 is maintained in a non-operating state.

When there is vibration having a higher frequency than that of the above-mentioned engine shake vibration, that is, vibration during idling or vibration during cylinder cut-off due to rotation of the engine crankshaft, the liquid within the through passage 32 providing communication between the first liquid chamber 30 and the third liquid chamber 35 becomes stationary and a vibration isolation function cannot be exhibited; the actuator 41 is therefore driven to exhibit a vibration isolation function.

In order to operate the actuator 41 of the active vibration isolation support system M to exhibit the vibration isolation function, the electronic control unit U controls the supply of current to the coil 46 based on a signal from the crank pulse sensor Sa.

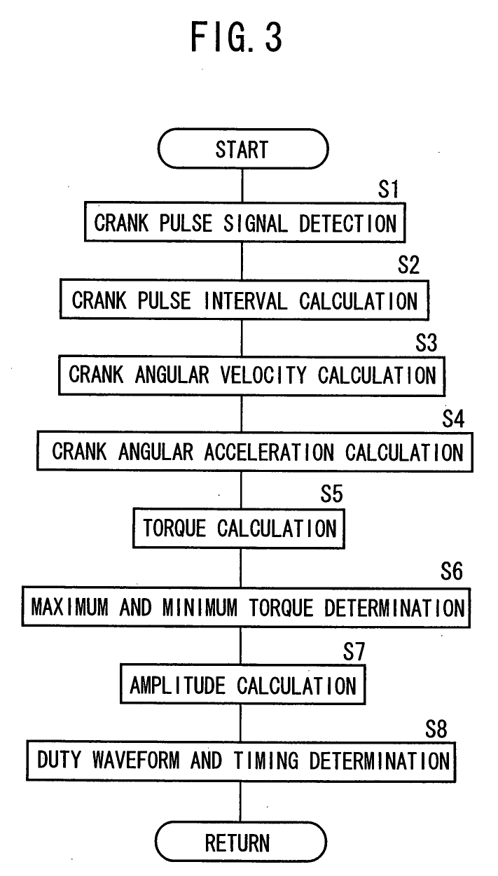

That is, in the flow chart of FIG. 3, firstly in step S1, crank pulses output from the crank pulse sensor Sa every 15° of crank angle are read in. In step S2, the crank pulses thus read in are compared with a reference crank pulse (TDC signal of a specified cylinder) so as to calculate a time interval between the crank pulses. In step S3, a crank angular velocity ω is calculated by dividing the 15° crank angle by the time interval between the crank pulses. In step S4, a crank angular acceleration dω/dt is calculated by differentiating the crank angular velocity ω with respect to time. In step S5, a torque Tq around the engine crankshaft is calculated from

Tq=I×dω/dt,

where I is the moment of inertia around the engine crankshaft. This torque Tq becomes 0 if it is assumed that the crankshaft rotates at a constant angular velocity ω, but in an expansion stroke the angular velocity ω increases by acceleration of a piston, and in a compression stroke the angular velocity ω decreases by deceleration of the piston, thus generating a crank angular acceleration dω/dt; as a result a torque Tq that is proportional to the crank angular acceleration dω/dt is generated.

In step S6, a maximum value and a minimum value of two successive torque values are determined. In step S7, amplitude at the position of the active vibration isolation support system M supporting the engine is calculated as the difference between the maximum value and the minimum value of the torque, that is, a torque variation. In step S8, a duty waveform and timing (phase) of current applied to the coil 46 of the actuator 41 are determined.

Thus, when the engine moves downward relative to the vehicle body frame and the first elastic body 19 is deformed downwardly thereby decreasing the capacity of the first liquid chamber 30, energizing the coil 46 of the actuator 41 with matching timing allows the movable core 54 to move downward toward the stationary core 42 by means of the attractive force generated in the air gap g, and the second elastic body 27 is deformed downwardly by being drawn by the movable member 28 connected to the movable core 54 via the rod 55. As a result, the capacity of the second liquid chamber 31 increases, so that the liquid in the first liquid chamber 30 which is compressed by the load from the engine, passes through the through hole 29a of the partition member 29 and flows into the second liquid chamber 31, thereby reducing the load transmitted from the engine to the vehicle body frame.

Subsequently, when the engine moves upward relative to the vehicle body frame and the first elastic body 19 is deformed upwardly thereby increasing the capacity of the first liquid chamber 30, de-energizing the coil 46 of the actuator 41 with matching timing allows the attractive force generated in the air gap g to disappear and the movable core 54 to move freely, so that the second elastic body 27 that has been deformed downwardly recovers upwardly by its own elastic recovery force. As a result, the capacity of the second liquid chamber 31 decreases, and the liquid in the second liquid chamber 31 passes through the through hole 29a of the partition member 29 and flows into the first liquid chamber 30, thereby allowing the engine to move upward relative to the vehicle body frame.

In this way, by energizing and de-energizing the coil 46 of the actuator 41 according to the cycle of vibration of the engine, it is possible to generate an active damping force that prevents vibration of the engine from being transmitted to the vehicle body frame.

In the conventional system, the actuator case 13 arranged within the lower housing 12 is made of strong iron-based material, and thus enhances the entire strength of the upper housing 11 and the lower housing 12. Therefore, when the front part of the body of the vehicle collides and a horizontal load acts on the flange portion 11a of the upper housing 11 projecting from the outer periphery of the active vibration isolation support system M, the upper housing 11 and the lower housing 12 tend to be difficult to be broken by the horizontal load, because of the presence of the actuator case 13. As a result, the engine bound to the vehicle body frame through the active vibration isolation support system M is difficult to be moved rearward by the impact of the collision, so that a sufficient clash stroke cannot be secured, leading to a possibility that the impact absorbing performance upon collision is lowered.

However, according to the present embodiment, the actuator case 13 is made of resin which is much more fragile than iron-based material, so that the actuator case 13 can be easily broken upon collision of the vehicle. Therefore, the entire strength of the upper housing 11 and the lower housing 12 is lowered and they are easily broken upon collision, thereby improving the impact absorbing performance.

Further, in order that the actuator 41 can effectively attract the movable core 54, a magnetic path is required to be formed so as to surround the coil assembly 43. In the conventional system, a part of the magnetic path is formed by the actuator case 13 made of iron-based material. However, in the present embodiment, the actuator case 13 is made of resin and the cylindrical shell 47 made of iron-based material is inserted thereinto. Therefore, a magnetic path can be formed so as to surround the coil assembly 43 with the stator 44, the shell 47, the stationary core 42, and the movable core 54, thereby securing a sufficient output of the actuator 41. Although the shell 47 is made of iron-based material, the weight of the actuator 41 can be drastically reduced as compared with the case where the entire actuator case 13 is made of iron-based material.

Furthermore, because the stator 44 and the shell 47 are integrally inserted into the actuator case 13, the number of assembling processes and the size of the actuator 41 can be reduced as compared with the case where they are assembled to the actuator case 13.

The embodiment of the present invention has been described above, but various changes in design may be made without departing from the subject matter of the present invention.

For example, although the active vibration isolation support system M supporting the engine of the automobile has been described in the embodiment, the active vibration isolation support system M of the present invention is applicable to support of any vibrating body other than the engine of the automobile.

What is claimed is:

1. An active vibration isolation support system comprising:
an elastic body for elastically supporting a vibrating body in a support system;
a liquid chamber defined by the elastic body and sealingly containing liquid therein;
a movable member for changing volume of the liquid chamber;
an actuator for driving the movable member; and
a housing which accommodates the elastic body, the liquid chamber, the movable member and the actuator therein, and which is connected to the support system; and
an actuator case comprising a resin member and holding an outer peripheral portion of the actuator in the housing.

2. The active vibration isolation support system according to claim 1, wherein the actuator case is molded while inserting a stator of the actuator thereinto.

3. The active vibration isolation support system according to claim 1, wherein the actuator case is molded while inserting a cylindrical shell thereinto, said shell comprising a magnetic body surrounding an outer periphery of the actuator.

4. The active vibration isolation support system according to claim 2, wherein the actuator case is molded while inserting a cylindrical shell thereinto, said shell comprising a magnetic body surrounding an outer periphery of the actuator.
